(19) United States
(12) Patent Application Publication
(10) Pub. No.: US 2019/0033534 A1
(43) Pub. Date: Jan. 31, 2019

(54) OPTICAL FIBER CONNECTOR, OPTICAL APPARATUS, OPTICAL TRANSCEIVER, AND METHOD OF MANUFACTURING OPTICAL FIBER CONNECTOR

(71) Applicant: SUMITOMO ELECTRIC INDUSTRIES, LTD., Osaka (JP)

(72) Inventors: Koichi KOYAMA, Osaka (JP); Akira FURUYA, Osaka (JP)

(73) Assignee: SUMITOMO ELECTRIC INDUSTRIES, LTD., Osaka (JP)

(21) Appl. No.: 16/032,769

(22) Filed: Jul. 11, 2018

(30) Foreign Application Priority Data
Jul. 28, 2017 (JP) 2017-146523

(51) Int. Cl. G02B 6/38; G02B 6/42

(52) U.S. Cl. CPC G02B 6/3878; G02B 6/4204; G02B 6/3825; G02B 6/3861; G02B 6/389; G02B 6/4256

(57) ABSTRACT

An optical fiber connector that optically couples a first optical fiber to a second optical fiber is disclosed. The optical fiber connector includes a first ferrule having a first through hole and a first end face, the first through hole receiving the first optical fiber; a second ferrule having a second through hole and a second end face, the second through hole receiving the second optical fiber, the second end face being apart from the first end face with a gap; a sleeve having a third through hole receiving the the first ferrule and the second ferrule; and an adhesive provided in the gap between the first and the second end faces. The first ferrule and the second ferrule are to be fixed to an inner peripheral surface of the sleeve with the adhesive.

### BACKGROUND OF THE INVENTION

### 1. Field of the Invention

The present invention relates to an optical fiber connector, an optical apparatus, and a method of manufacturing the optical fiber connector.

### 2. Description of the Related Art

Exemplary optical apparatuses each including optically coupled optical fibers are disclosed by Japanese Unexamined Patent Application Publications No. 2005-99769, No. 2011-118337, and No. 2015-125217. Specifically, a pigtail-type sub-assembly employing so-called splice connection in which optical fibers are fused and spliced to each other is disclosed by Japanese Unexamined Patent Application Publication No. 2005-99769. Furthermore, a receptacle-type sub-assembly employing so-called physical-contact connection is disclosed by each of Japanese Unexamined Patent Application Publications No. 2011-118337 and No. 2015-125217, in which optical fibers are optically coupled to each other such that respective end faces thereof are pressed against each other with the aid of a spring.

In the field of optical communications, the channel capacity has been increasing. Accordingly, the number of components forming an optical transceiver that can handle the increasing channel capacity has also been increasing. Hence, there have been demands for size reduction of the components forming such optical transceivers. An optical transceiver includes a portion where optical fibers are optically coupled to each other, and a portion where either of the optical fibers is optically coupled to an optical sub-assembly. Hence, the sizes of such optical coupling portions are desired to be reduced.

### SUMMARY OF THE INVENTION

According to an aspect of the present invention, there is provided an optical fiber connector that optically couples a first optical fiber to a second optical fiber, the optical fiber connector including a first ferrule having a first peripheral surface, a first through hole, and a first end face, the first through hole receiving the first optical fiber, a second ferrule having a second peripheral surface, a second through hole, and a second end face, the second through hole receiving the second optical fiber, the second end face being apart from the first end face with a gap, a sleeve having a third peripheral surface and a third through hole, the third through hole receiving the the first ferrule and the second ferrule, and an adhesive provided in the gap between the first and the second end faces. The first ferrule and the second ferrule are to be fixed to an inner peripheral surface of the sleeve with the adhesive.

### BRIEF DESCRIPTION OF THE DRAWINGS

FIG. 1 is a perspective view of an optical transceiver according to an embodiment.

FIG. 2 is a perspective view of optical fiber connectors that are attached to a housing.

FIG. 3A is a perspective view illustrating a section of an optical fiber connector according to the embodiment.

FIG. 3B is an enlarged front view illustrating a relevant part of FIG. 3A.

FIG. 4A is a perspective view illustrating a step included in a method of connecting optical fibers.

FIG. 4B is a perspective view illustrating another step included in the method of connecting optical fibers that follows the step illustrated in FIG. 4A.

FIG. 5A is a sectional view illustrating an exemplary state of optical coupling between optical fibers.

FIG. 5B is a sectional view illustrating another exemplary state of optical coupling between optical fibers.

FIG. 5C is a sectional view illustrating yet another exemplary state of optical coupling between optical fibers.

FIG. 5D is a sectional view illustrating yet another exemplary state of optical coupling between optical fibers.

FIG. 6 is a perspective view illustrating a section of an optical-transmitter sub-unit according to another embodiment.

FIG. 7A is an exploded perspective view of an optical fiber connector according to a modification.

FIG. 7B is a perspective view of the optical fiber connector according to the modification.

FIG. 8A is a perspective view of an optical fiber connector according to another modification.

FIG. 8B is a perspective view of an optical fiber connector according to yet another modification.

FIG. 9 is a perspective view illustrating another exemplary configuration in which optical fiber connectors are attached to a housing.

### DESCRIPTION OF THE PREFERRED EMBODIMENTS

### Description of Embodiments of the Invention

According to an embodiment of the present invention, there is provided (1) an optical fiber connector that optically couples a first optical fiber to a second optical fiber. The optical fiber connector includes a first ferrule having a first peripheral surface, a first through hole, and a first end face, the first through hole receiving the first optical fiber; a second ferrule having a second peripheral surface, a second through hole, and a second end face, the second through hole receiving the second optical fiber, the second end face being apart from the first end face with a gap; a sleeve having a third peripheral surface and a third through hole, the third through hole receiving the the first ferrule and the second ferrule; and an adhesive provided in the gap between the first and the second end faces. The first ferrule and the second ferrule are to be fixed to an inner peripheral surface of the sleeve with the adhesive.

The first ferrule and the second ferrule are inserted into the sleeve, which has a cylindrical shape. Therefore, the center axis of the first ferrule can be made to coincide with the center axis of the second ferrule. Accordingly, the optical axis of the first optical fiber in the first ferrule and the optical axis of the second optical fiber in the second ferrule are aligned with each other. Therefore, the first optical fiber and the second optical fiber are optically coupled to each other. The first end face is fixed to the second end face with the adhesive. The first ferrule is fixed to the sleeve with the adhesive. The second ferrule is also fixed to the sleeve with the adhesive. Thus, the relative positions among the pair of ferrules and the sleeve are retained. Hence, the relative positions between the optical axis of the first optical fiber and the optical axis of the second optical fiber are retained. Accordingly, the first optical fiber and the second optical fiber are kept optically coupled to each other. The relative positions between the optical axis of the first optical fiber and the optical axis of the second optical fiber are retained by using the adhesive. Such a connecting method provides satisfactory strength. Hence, there is no need to provide a separate reinforcing member for providing strength. Moreover, there is no need to press the second optical fiber against the first optical fiber for retaining the relative positions between the optical axis of the first optical fiber and the optical axis of the second optical fiber. Accordingly, there is no need to provide a separate pressing mechanism. Therefore, the optical fibers can be optically coupled to each other without any additional components. Consequently, the size of the portion where optical fibers are optically coupled to each other can be reduced.

(2) The first and the second end faces may be surrounded by a first and a second chamfers. The first and the second chamfers are in contact with the adhesive.

(3) The sleeve may include a slit hole connecting the third peripheral surface and the inner peripheral surface of the third through hole, and the first and the second peripheral surfaces of the first and the second ferrules. The first and the second ferrules, and the adhesive are exposed from the slit hole. With the slit hole, the adhesive can be fed into the gap between the first end face and the second end face after the ferrules are inserted into the sleeve. Moreover, an excessive portion of the adhesive can be discharged from the gap through the slit hole. Accordingly, the size of the gap between the first end face and the second end face can be regulated to a predetermined length. Therefore, the optical coupling loss related to the gap between the first end face and the second end face can be reduced.

(4) The slit hole may extend through the sleeve from one end to the other end of the sleeve. In such a configuration, while the strength of the sleeve is maintained, the feeding of the adhesive into the gap between the first exposed end face and the second exposed end face and the discharge of the adhesive from the gap can be performed. The position of the gap between the first end face and the second end face is determined by the depth of insertion of the ferrules into the sleeve. In such a configuration, the gap between the first end face and the second end face is open to the outside regardless of the depth of insertion of the ferrules into the sleeve. Therefore, the depth of insertion of the ferrules does not need to be strictly regulated. Accordingly, the optical fiber connector can be assembled easily.

According to another embodiment of the present invention, there is provided an optical apparatus including a first optical fiber, a second optical fiber, the optical fiber connector according to any of (1) to (4) above that optically couples the first optical fiber to the second optical fiber, and an sub-assembly connected to the first and second ferrules and including a light-emitting element. The housing includes a holder portion holding the optical fiber connector. In such a configuration, no additional components are necessary in optically coupling the first optical fiber to the second optical fiber. Therefore, the size of the optical apparatus can be reduced. In such a configuration, the size of the portion where the first optical fiber is optically coupled to the second optical fiber can be reduced. Consequently, the size of the housing can be reduced. Moreover, the number of components to be provided in the housing can be increased.

According to yet another embodiment of the present invention, there is provided a method of manufacturing an optical fiber connector in which a first optical fiber is optically coupled to a second optical fiber. The method includes a step of preparing a first ferrule having a first peripheral surface, a first through hole, and a first end face, the first through hole receiving first optical fiber, and a second ferrule having a second peripheral surface, a second through hole, and a second end face, the second through hole receiving the second optical fiber, and a sleeve having a third peripheral surface and a third through hole; a step of applying an adhesive to the first and/or the second end faces of the first and/or the ferrules, the adhesive being uncured; a step of inserting the first ferrule and the second ferrule into the third through hole of the sleeve, the second end face being apart from the first end face with a gap; and a step of curing the adhesive so that the adhesive fixes the first and the second ferrules inside the third through hole of the sleeve. In such a method, the first optical fiber can be optically coupled to the second optical fiber without using any additional components. Hence, the size of the portion where the first optical fiber is optically coupled to the second optical fiber can be reduced.

In the third step, a predetermined gap may be provided between the first-optical-fiber end face and the second-optical-fiber end face, and the adhesive is provided in the gap. Furthermore, in the fourth step, the adhesive may be cured after the first ferrule restrained to the sleeve is released and the second ferrule restrained to the sleeve is released. In such a method, the generation of internal stress that may act on the first optical fiber and the second optical fiber is suppressed. Accordingly, the first optical fiber and the second optical fiber become less likely to be displaced from each other. Hence, a good state of optical coupling can be maintained.

### Details of Embodiments of the Invention

Specific embodiments of the optical fiber connector in which the size of an optical coupling portion can be reduced; the optical apparatus, the optical transmitter, the optical receiver, and the optical transceiver each including the optical fiber connector; and the optical-fiber-connecting method according to the present invention will now be described with reference to the accompanying drawings. The present invention is not limited to the following embodiments. It is intended that the scope of the present invention be defined by the appended claims and includes all equivalents to the claims and all changes made to the claims within the scope thereof.

### First Embodiment

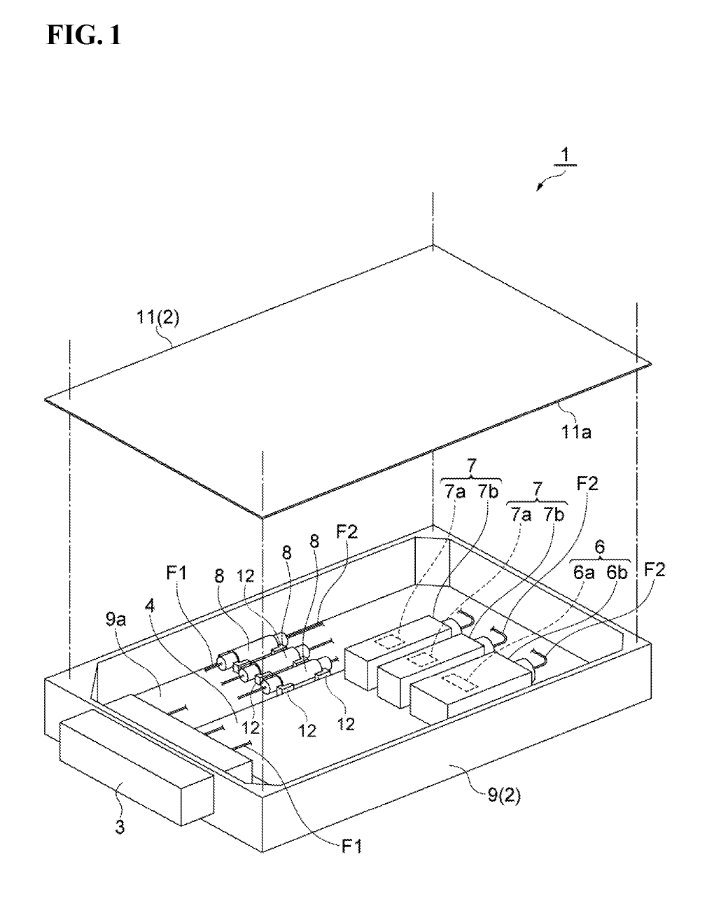

Referring to FIG. 1, an optical transceiver 1 according to a first embodiment includes a housing 2, a connector 3, a circuit board 4, a transmitter optical sub-assembly (TOSA: hereinafter simply referred to as “TOSA 6”), receiver optical sub-assemblies (ROSAs: hereinafter simply referred to as “ROSAs 7”), and optical fiber connectors 8. The connector 3 is provided with optical cables (not illustrated) on the outer side thereof and with optical fibers F1 (first optical fibers) on the inner side thereof. The TOSA 6, the ROSA 7, and optical fiber connectors 8 are arranged on a bottom of the housing 2.

The TOSA 6 includes a laser diode 6a serving as a light-emitting element, and a case 6b that houses the laser diode 6a. The TOSA 6 is connected to an optical fiber F2 (a second optical fiber) for outputting an optical signal. The ROSAs 7 each include a photodiode 7a serving as a light-receiving element, and a case 7b that houses the photodiode 7a. The ROSAs 7 are connected to other optical fibers F2 (second optical fibers), respectively, for receiving optical signals.

The optical fiber connectors 8 optically couple the optical fibers F1 extending from the connector 3 to the optical fibers F2 extending from the TOSA 6 and from the ROSAs 7, respectively. The housing 2 includes a case 9 and a lid 11. The housing 2 has a plurality of holder portions 12 on the case 9. The optical fiber connectors 8 are loosely fitted in the holder portions 12. The lid 11 may have a soft convex part such as a sponge. The optical fiber connectors 8 may be caught with the soft convex part, the holder portions 12, and a bottom of the case 9, so as not to be suffered from an excessive force from the housing 2. Alternatively, the optical fiber connectors 8 may be in the holder portions 12.

The housing 2 houses the circuit board 4, the TOSA 6, the ROSAs 7, and the optical fiber connectors 8. The lid 11 is fixed to the case 9 with screws or the like. The connector 3 is fixed to the housing 2. That is, the connector 3 optically couples the external optical cables and the optical fibers F1 to each other. The circuit board 4 is a plate-like component chiefly made of glass epoxy. The circuit board 4 is fixed to the housing 2 with screws or the like. The circuit board 4 is provided on the surface thereof with a circuit pattern that conducts electricity and with several electronic components. The circuit board 4 is electrically connected to the TOSA 6 and to the ROSAs 7.

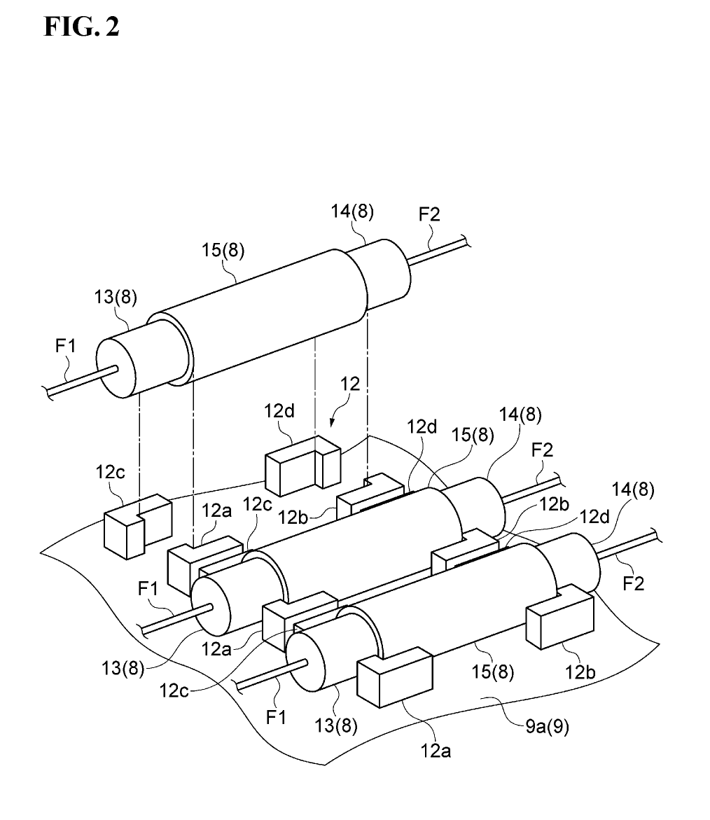

Referring to FIG. 2, the optical fiber connectors 8 are fitted in the holder portions 12, respectively. The holder portions 12 are provided on a bottom surface 9a of the case 9. Each holder portion 12 holds the optical fiber connector 8. The holder portions 12 each include four standing parts 12a, 12b, 12c, and 12d each having an L-shape in plan view. The distance between a pair of standing parts 12a and 12b corresponds to the length of the sleeve 15. Specifically, the distance between the pair of standing parts 12a and 12b is substantially equal to or slightly greater than the length of the sleeve 15. The distance between another pair of standing parts 12a and 12c corresponds to the diameter of a ferrule 13. Specifically, the distance between the pair of standing parts 12a and 12c is substantially equal to or slightly greater than the diameter of the ferrule 13. The holder portions 12 may be provided not only on the bottom surface 9a but also on a back surface 11a (see FIG. 1) of the lid 11 that faces the bottom surface 9a. In that case, the optical fiber connectors 8 are each held between a corresponding one of pairs of the holder portions 12 in the vertical direction.

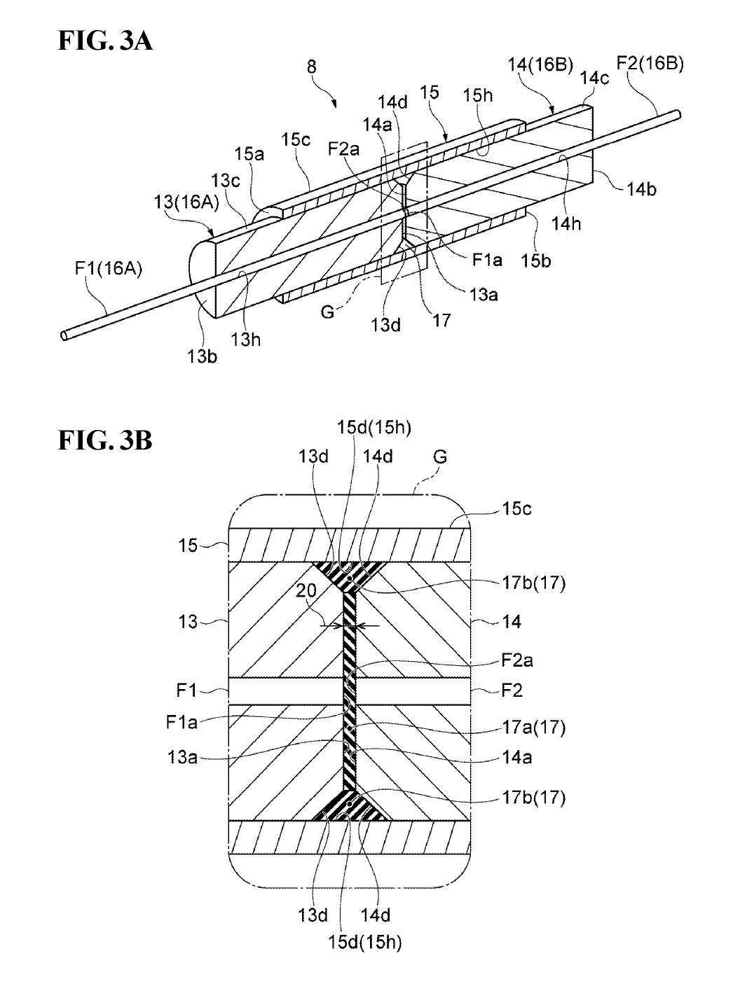

Referring to FIG. 3A, each of the optical fiber connectors 8 includes a pair of ferrules 13 and 14, and the sleeve 15. The pair of ferrules 13 and 14 are inserted in the through hole of the sleeve 15. A leading end face 13a of the ferrule 13 and a leading end face 14a of the ferrule 14 are facing each other with an adhesive 17 interposed therebetween. The pair of ferrules 13 and 14 have the same shape and the same configuration. Therefore, the ferrule 13 will be described in detail, and detailed description of the ferrule 14 is omitted.

The ferrule 13 is a cylindrical member. The ferrule 13 has a leading end face 13a, a trailing end face 13b, an outer peripheral surface 13c, and a through hole 13h. The leading end face 13a is a surface that faces the other ferrule 14 and is positioned inside the sleeve 15. The trailing end face 13b is a surface that is opposite the leading end face 13a and is positioned outside the sleeve 15. The outer peripheral surface 13c extends between the leading end face 13a and the trailing end face 13b. The outer peripheral surface 13c and the leading end face 13a may be connected to each other with a chamfer 13d interposed therebetween. The chamfer 13d may be a sloping surface or a curved surface. The trailing end face 13a is surrounded with the chamfer 13d. The through hole 13h is a hole extending from the trailing end face 13b to the leading end face 13a. The through hole 13h receives the optical fiber F1 inserted thereinto. The optical fiber F1 is inserted into the through hole 13h from the side of the trailing end face 13b. An end face F1a of the optical fiber F1 is exposed on the leading end face 13a and is in contact with the adhesive 17. The end face F1a of the optical fiber F1 is flush with the leading end face 13a. The ferrule 13 to which the optical fiber F1 is attached as described above forms a ferrule unit 16A according to the first embodiment.

The sleeve 15 has a cylindrical shape. The sleeve 15 has an outer peripheral surface 15c and an inner surface. The sleeve 15 has a sleeve hole 15h extending therethrough from one end 15a to an other end 15b. The inside diameter of the sleeve hole 15h is substantially equal to or very slightly greater than the outside diameter of the ferrule 13. The length of the sleeve 15 is shorter than the length from the trailing end face 13b of the one ferrule 13 to a trailing end face 14b of the other ferrule 14. Hence, the trailing end faces 13b and 14b of the ferrules 13 and 14 project from the ends 15a and 15b of the sleeve 15, respectively. The sleeve 15 retains the relative positional relationship between the leading end face 13a of the ferrule 13 and a leading end face 14a of the ferrule 14. That is, the sleeve 15 aligns the ferrules 13 and 14 with each other at respective appropriate positions for optical coupling therebetween. The term “relative positional relationship” used herein implies the relative positions in a direction orthogonal to the optical axes of the optical fibers F1 and F2, and the distance in a direction parallel to the optical axes of the optical fibers F1 and F2 from the one leading end face 13a to the other leading end face 14a.

The length of the sleeve 15 is 4.0 mm. The inner diameter of the sleeve 15 is about 1.25 mm. The outer diameter of the ferrule 13 is 1.2490 mm+/−0.0005 mm. The length of the ferrule 13 is 4.0 mm. The gap between the trailing end face 13a and the trailing end face 14a inside the sleeve hole 15h is 0.010 mm+/−0.009 mm, preferably 0.005 mm+/−0.004 mm.

The sleeve 15 and the ferrule 13 are both made of, for example, zirconia. That is, the sleeve 15 and the ferrule 13 may be made of the same material. If the sleeve 15 and the ferrule 13 are made of the same material, the sleeve 15 and the ferrule 13 have the same thermal expansion rate with respect to temperature change. Under such a condition, thermal stress that usually occurs with a difference in thermal expansion rate is less likely to occur between the sleeve 15 and the ferrule 13 even if the optical fiber connector 8 is heated or cooled. Therefore, the occurrence of displacement of an end face F2a of the optical fiber F2 with respect to the end face F1a of the optical fiber F1 is suppressed. Consequently, the optical coupling loss that may occur if there is any displacement between the end face F1a and the end face F2a is suppressed.

Referring now to FIG. 3B, the pair of ferrules 13 and 14 are positioned such that the leading end faces 13a and 14a thereof face each other at the center of the sleeve 15. Specifically, a gap 20 is provided between the leading end faces 13a and 14a, and the gap 20 is filled with the adhesive 17. That is, the pair of ferrules 13 and 14 are fixed to each other with the adhesive 17. In such a configuration, the distance from the one leading end face 13a to the other leading end face 14a in the direction parallel to the optical axis of the optical fiber F1 is maintained. The adhesive 17, which is thermosetting, is transparent to light that is transmitted through the optical fibers F1 and F2, for example, light having a wavelength of 1.55 μm. The refractive index of the adhesive 17 that has been cured with heat is substantially equal to the refractive index of the core of each of the optical fibers F1 and F2.

The gap 20 includes two areas. A first area is between the leading end faces 13a and 14a. The first area is filled with adhesive 17a. The adhesive 17a fixes the leading end faces 13a and 14a to each other. A second area is enclosed by the chamfer 13d, a chamfer 14d, and an inner peripheral surface 15d of the sleeve 15. The second area is filled with adhesive 17b. The adhesive 17b fixes the chamfer 13d and the chamfer 14d to each other, the chamfer 13d and the sleeve 15 to each other, and the chamfer 14d and the sleeve 15 to each other.

The optical fiber connector 8 described above is formed as follows.

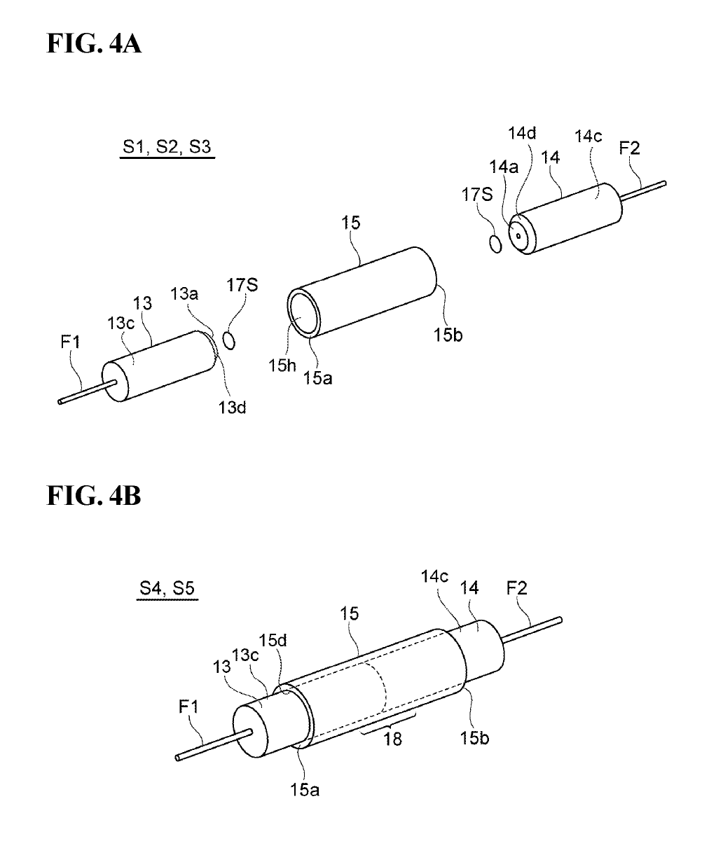

First, as illustrated in FIG. 4A, a pair of ferrules 13 and 14 are prepared (step S1), and a sleeve 15 is prepared (step S2). In these steps, the optical fibers F1 and F2 have already been attached to the ferrules 13 and 14, respectively. Subsequently, uncured adhesive 17S is applied to the leading end face 13a of the one ferrule 13 and/or the leading end face 14a of the other ferrule 14 (step S3). The uncured adhesive 17S has higher fluidity than the adhesive 17 that has been cured with heat. In this step, the amount of uncured adhesive 17S to be applied may be set in accordance with the volumes of the first area and the second area.

When the ferrules 13 and 14 to which the uncured adhesive 17S has been applied are inserted into the sleeve 15, the adhesive 17S spreads over the space enclosed by the pair of ferrules 13 and 14 and the sleeve 15. This space is defined by the inside diameter of the sleeve hole 15h of the sleeve 15, the sizes of the chamfers 13d and 14d, and the distance between the leading end faces 13a and 14a. The inside diameter of the sleeve 15 and the sizes of the chamfers 13d and 14d are predetermined in accordance with the shapes thereof and do not change. In contrast, the distance between the leading end faces 13a and 14a changes with the depth of insertion of the ferrules 13 and 14. Hence, if the amount of uncured adhesive 17S is too large, the distance between the leading end faces 13a and 14a increases so that a space enough for receiving such uncured adhesive 17S can be provided. Considering the optical coupling loss, a long distance between the leading end faces 13a and 14a is disadvantageous. Therefore, the amount of uncured adhesive 17S is regulated such that the distance between the leading end faces 13a and 14a falls within a predetermined value.

Subsequently, as illustrated in FIG. 4B, the ferrules 13 and 14 are inserted into the sleeve 15 (step S4). In this step, the one ferrule 13 is inserted into the sleeve 15 from the one end 15a while the other ferrule 14 is inserted into the sleeve 15 from the other end 15b so that the leading end faces 13a and 14a of the ferrules 13 and 14 face each other. As the uncured adhesive 17S has a high fluidity, the ferrules 13 and 14 can be inserted into the through hole of the sleeve 15 with the adhesive 17S. As the uncured adhesive 17S has a high fluidity, a small amount of the uncured adhesive 17S is spread by capillary phenomenon into a slight clearance between the inner peripheral surface 15d of the sleeve 15 and the outer peripheral surfaces 13c and 14c of the ferrules 13 and 14.

Furthermore, the leading end faces 13a and 14a are brought into contact with each other such that no force that causes the one leading end face 13a to press the other leading end face 14a is generated. Specifically, once the one leading end face 13a comes into contact with the other leading end face 14a, the ferrule 13 is no longer pushed into the sleeve 15. That is, the leading end faces 13a and 14a are simply in contact with each other with the uncured adhesive 17S interposed therebetween, and no force is generated between the two. More specifically, after the leading end faces 13a and 14a are brought into contact with each other, the ferrules 13 and 14 that have been held are released. That is, the worker never touches the ferrules 13 and 14 but holds the sleeve 15 after performing step S4.

Performing step S4 suppresses the occurrence of internal stress that usually occurs when the pressing force is applied to the optical fibers F1 and F2. Accordingly, the displacement of the optical fibers F1 and F2 relative to each other becomes less likely to occur. Consequently, a good state of optical coupling is maintained.

Then, with the sleeve 15 being held, the uncured adhesive 17S is cured (step S5). Specifically, an optical-fiber-coupling portion 18 including the uncured adhesive 17S is heated by a heater or the like. The cured adhesive 17 steadily fixes the position of the ferrules 13 and 14 inside the through hole of the sleeve 15.

Through steps S1 to S5 described above, the optical fibers F1 and F2 are optically coupled to each other.

Now, advantageous effects produced by the optical fiber connector 8, the optical transceiver 1, and the method of connecting the optical fibers F1 and F2 according to the first embodiment will be described.

In recent years, the traffic in optical communications has been increasing significantly, and the enhancement of the channel capacity has been demanded. To increase the channel capacity, a method such as wavelength division multiplexing (WDM) or space division multiplexing (SDM) is employed. Furthermore, the transmission speed demanded for optical transceivers has been increasing acceleratingly. Optical transceivers are based on several standards such as centum gigabit form factor pluggable (CFP) and quad small form factor pluggable (QSFP). An optical transceiver employed in the WDM method according to any of the standards includes a casing and one or more components, such as a transmitter optical sub-assembly (TOSA) and a receiver optical sub-assembly (ROSA), housed in the casing. Such components are optically coupled to one another in the casing with the aid of optical fibers. An optical transceiver employing an SDM method includes, for example, a component based on a silicon photonics technology in which the functions of TOSA and ROSA are monolithically integrated. Such a component is optically coupled to a light-source sub-assembly with the aid of an optical fiber.

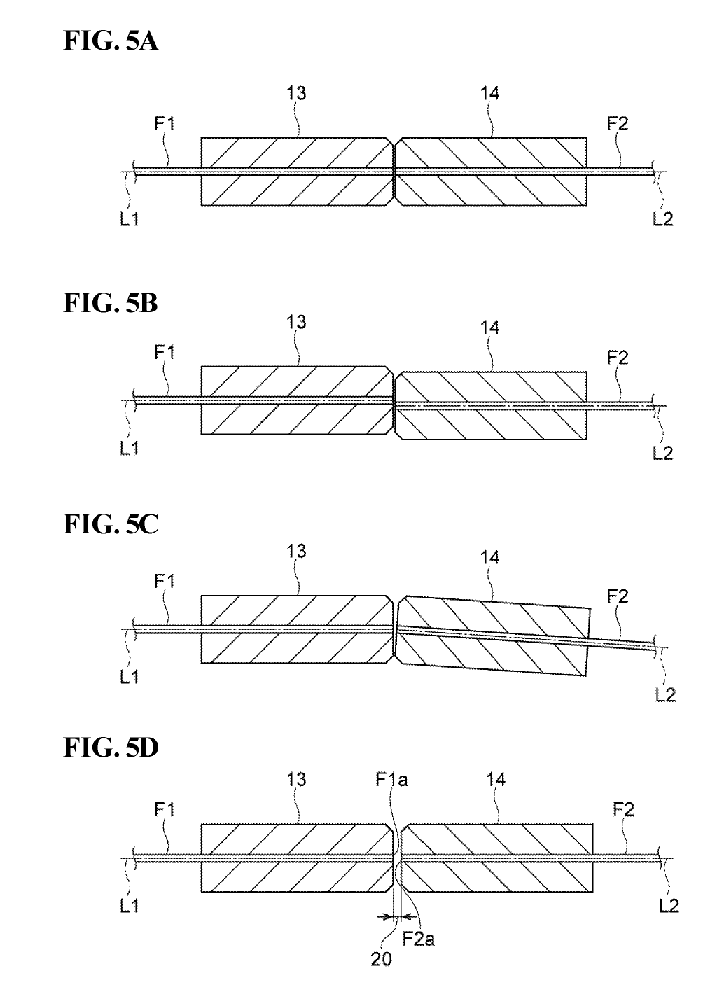

In the optical coupling between optical fibers, as illustrated in FIG. 5A, it is desirable that an optical axis L1 of the one optical fiber F1 coincide with an optical axis L2 of the other optical fiber F2. However, the optical axis L1 of the one optical fiber F1 may be displaced from the optical axis L2 of the other optical fiber F2 while being parallel thereto (see FIG. 5B), or the optical axis L1 of the one optical fiber F1 may be tilted with respect to the optical axis L2 of the other optical fiber F2 (see FIG. 5C). If there is any displacement or tilt between the optical axes L1 and L2, some optical loss occurs. As illustrated in FIG. 5D, if there is a gap 20 between the end face F1a of the one optical fiber F1 and the end face F2a of the other optical fiber F2, light may be reflected by the end face F2a that is on the light-receiving side. If such reflected light enters the end face F1a that is on the light-emitting side, the light source connected to the optical fiber F1 may cause a failure.

Connecting methods that suppress the displacement between two optical fibers as described above include fusion splicing and butt coupling. In fusing splicing, respective ends of two optical fibers are fused and spliced to each other. The fusion-spliced portion is provided with a protection member for imparting strength of a certain level so that the fusion-spliced portion is not damaged when the optical fibers are housed in the casing. The protection member has a stick-like shape with a certain length. The protection member is unfoldable. Therefore, when the optical fibers are wound in a coil and stored in the casing of the optical transceiver, the fusion-spliced portion occupies a space of a certain size. In butt coupling, an end face of one of the two optical fibers is pressed against an end face of the other optical fiber. Such a connecting method is referred to as physical-contact (PC) connection. The force for pressing the one optical fiber to the other optical fiber is generated by using a spring or the like. Hence, if the PC connection is employed, a spring and a flange structure for optical coupling are necessary. Consequently, the configuration at the optical coupling portion becomes complicated. Therefore, the proportion of the optical coupling portion in the space inside the casing increases. Moreover, the spring expands or contracts with temperature change. That is, the magnitude of the force that causes the end face of one optical fiber to the end face of the other optical fiber changes with temperature. Such changes in the pressing force may change the optical coupling efficiency. For example, in the case of PC connection, if the temperature changes within a predetermined range (from −40° C. to +85° C.), a change in the optical coupling loss of about 0.3 dB or smaller occurs. If an optical fiber is removed from the sleeve and reinserted into the sleeve, a change in the optical coupling loss of about 0.2 dB or smaller occurs.

The optical fiber connector 8 according to the first embodiment employs the adhesive 17 having a small volume provided at the optical coupling portion. Such a configuration requires neither spring nor flange. That is, the optical fiber connector 8 can be packaged even in a narrow space inside the casing. Furthermore, since the adhesive used for optical coupling has a small volume, the optical fiber connector 8 is less susceptible to thermal expansion and contraction than in the case where a spring is employed. Accordingly, the change in the optical coupling efficiency that is caused by temperature change is suppressed. Moreover, since the adhesive 17 fixes the optical fibers F1 and F2 to each other, the optical fibers F1 and F2 are not removable from the sleeve 15. Therefore, the change in the optical coupling loss due to the insertion and removal of the optical fibers F1 and F2 into and from the sleeve 15 does not occur at all.

More specifically, the pair of ferrules 13 and 14 are each inserted into the cylindrical sleeve 15. Hence, the center axis of the ferrule 13 can be made to coincide with the center axis of the ferrule 14. That is, the optical axis L1 of the optical fiber F1 in the ferrule 13 and the optical axis L2 of the optical fiber F2 in the ferrule 14 are aligned with each other. Hence, the optical fibers F1 and F2 are optically coupled to each other. Furthermore, the leading end face 13a is fixed to the leading end face 14a with the adhesive 17a, and the ferrule 13 and the ferrule 14 are fixed to the sleeve 15 with the adhesive 17b. Thus, the relative positions among the pair of ferrules 13 and 14 and the sleeve 15 are retained. Accordingly, the relative position of the optical axis L2 of the optical fiber F2 with respect to the optical axis L1 of the optical fiber F1 is retained. Consequently, the optical fiber F1 and the optical fiber F2 are kept optically coupled to each other.

The relative positions between the optical axis L1 of the optical fiber F1 and the optical axis L2 of the optical fiber F2 are retained by using the adhesive 17 and the sleeve 15. Such a connecting structure is strong enough not to be damaged when optical fibers are attached to a casing. Therefore, the connecting structure requires no additional protection member. Moreover, there is no need to press the optical fiber F2 against the optical fiber F1 for retaining the relative positions between the optical axis L1 of the optical fiber F1 and the optical axis L2 of the optical fiber F2. Hence, no separate pressing mechanism is necessary. Therefore, the optical fibers F1 and F2 can be optically coupled to each other with no additional components. Consequently, the size of the optical coupling portion can be reduced.

### Second Embodiment

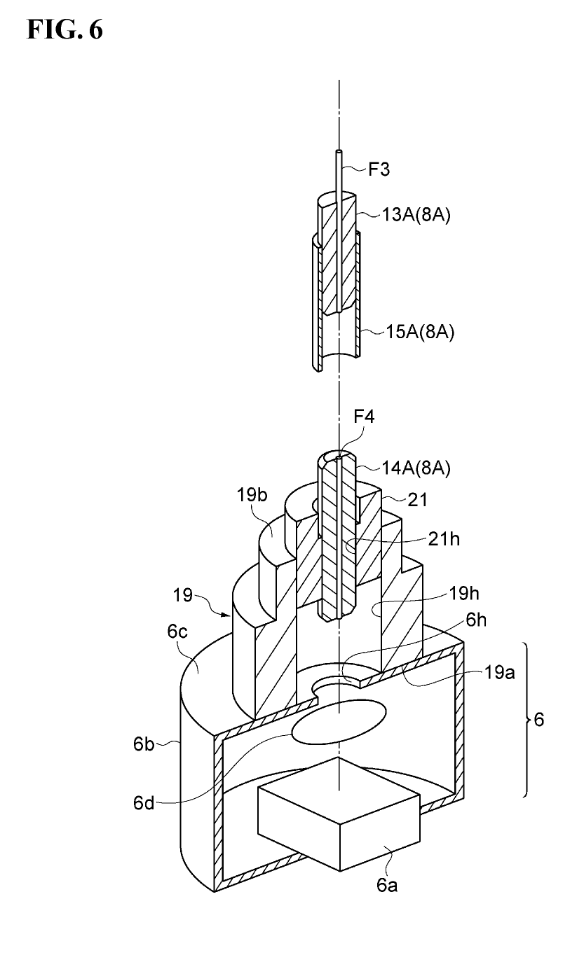

Referring to FIG. 6, an optical fiber connector 8A according to a second embodiment may be used as a structure in which an optical fiber F3 is optically coupled to an optical sub-assembly such as a TOSA 6. An exemplary configuration of connecting the optical fiber F3 to the TOSA 6 will now be described.

A case 6b of the TOSA 6 houses a laser diode 6a and an optical component 6d such as a lens. A case end face 6c of the TOSA 6 has a light-passing hole 6h. The case end face 6c is provided with a guide 19. The guide 19 is a cylindrical member and includes a proximal end face 19a, a distal end face 19b, and a through hole 19h. The proximal end face 19a is fixed to the case end face 6c. An opening of the through hole 19h that is on the side of the distal end face 19b is provided with a stub-holding portion 21. An other opening of the through hole 19h that is on the side of the proximal end face 19a communicates with the light-passing hole 6h. The stub-holding portion 21 is a cylindrical member. The proximal side of the stub-holding portion 21 is fitted in the through hole 19h of the guide 19. The distal side of the stub-holding portion 21 is provided with a ferrule 14A inserted thereinto. That is, a ferrule 13A is fixed to the TOSA 6 with the stub-holding portion 21 and the guide 19 interposed therebetween. The ferrules 13A and 14A and a sleeve 15A have the same configurations as the ferrules 13 and 14 and the sleeve 15 according to the first embodiment, respectively. An adhesive (not shown) is provided inside the sleeve 15 to fill a gap between end faces of the ferrules 13 and 14. Light emitted from the laser diode 6a is optically coupled to one end of an optical fiber F4 through the lens 6d. The light is guided through the optical fiber F4 and is optically coupled at the other end of the optical fiber F4 to one end of the optical fiber F3.

In such a configuration, the optical fiber F3 is optically coupled to the optical fiber F4 of the TOSA 6 with no additional components such as a spring and a protection member. Therefore, the portion where the optical fiber F3 is connected to the TOSA 6 can be made smaller (shorter).

### First Modification

While some embodiments of the present invention have been described above, the present invention is not limited to the above embodiments.

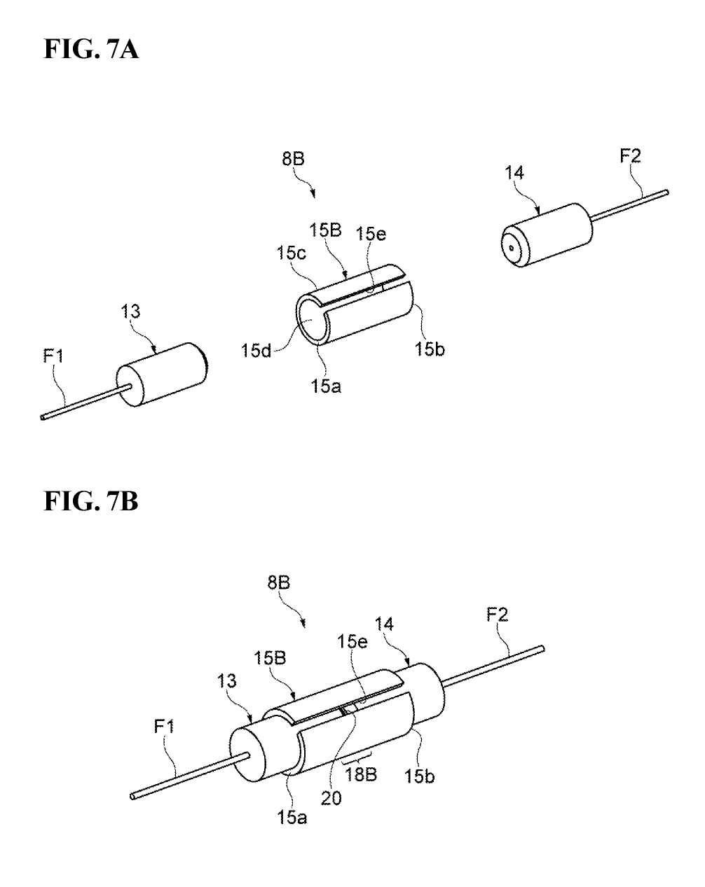

For example, as illustrated in FIG. 7A, an optical fiber connector 8B including a slit sleeve 15B in replacement of the sleeve 15 may be employed. The slit sleeve 15B has a stripe slit 15e. The stripe slit 15e extends from one end 15a to an other end 15b of the slit sleeve 15B. The stripe slit 15e extends through the slit sleeve 15B from an inner peripheral surface 15d of the through hole to an outer peripheral surface 15c. The outer peripheral surfaces of the ferrules 13 and 14 are exposed through the stripe slit 15e. The gap 20 filled with an adhesive is also exposed from the stripe slit 15e.

The optical fiber connector 8B including the slit sleeve 15B is assembled as follows. First, a pair of ferrules 13 and 14 provided with optical fibers F1 and F2, respectively, and a slit sleeve 15B are prepared. Subsequently, the ferrules 13 and 14 are inserted into the slit sleeve 15B. In this step, as illustrated in FIG. 7B, a portion where a pair of leading end faces 13a and 14a come into contact with each other is exposed from the stripe slit 15e of the slit sleeve 15B. Specifically, an area enclosed by a pair of chamfers 13d and 14d and the inner peripheral surface 15d of the slit sleeve 15B is open to the outside from the stripe slit 15e. Therefore, uncured adhesive is directly fed into this area from the stripe slit 15e. Then, an optical-fiber-coupling portion 18B provided with the uncured adhesive is heated, whereby the uncured adhesive is cured.

The optical fiber connector 8B according to the first modification includes the slit sleeve 15B. With the slit sleeve 15B, an excessive portion of the adhesive spreads over the stripe slit 15e. Therefore, the thickness of the adhesive can be reduced. That is, the excessive portion of the uncured adhesive can be released to the outside from the stripe slit 15e so as not to remain in the gap between the leading end faces 13a and 14a. Thus, the increase in the thickness of the adhesive (the distance between the leading end faces 13a and 14a) is suppressed. Consequently, the increase in the optical coupling loss is suppressed.

More specifically, the stripe slit 15e as a slit allows the gap 20 between the leading end faces 13a and 14a to be open to the outside. Hence, with the stripe slit 15e, uncured adhesive can be fed into the gap 20 between the leading end faces 13a and 14a after the ferrules 13 and 14 are inserted into the sleeve 15. Furthermore, the excessive portion of the uncured adhesive can be discharged from the gap 20 between the leading end faces 13a and 14a. Hence, the size of the gap 20 between the leading end faces 13a and 14a can be regulated to a predetermined length. Consequently, the increase in the optical coupling loss related to the gap 20 between the leading end faces 13a and 14a can be suppressed.

Furthermore, the slit sleeve 15B allows ultraviolet light (UV light) to be applied to the adhesive from the stripe slit 15e. Hence, UV-curable adhesive or adhesive that is curable with a combination of UV light and heat can be employed. In such a configuration, relatively high bonding strength can be provided.

Furthermore, with the slit sleeve 15B, the gap 20 between the leading end faces 13a and 14a is open to the outside regardless of the depth of insertion of the ferrules 13 and 14 into the slit sleeve 15B. Moreover, the positions of the leading end faces 13a and 14a and the distance between the leading end faces 13a and 14a can be checked visually from the stripe slit 15e. Hence, there is no need to strictly regulate the depth of insertion of the ferrules 13 and 14, and the optical fiber connector 8B can be assembled easily.

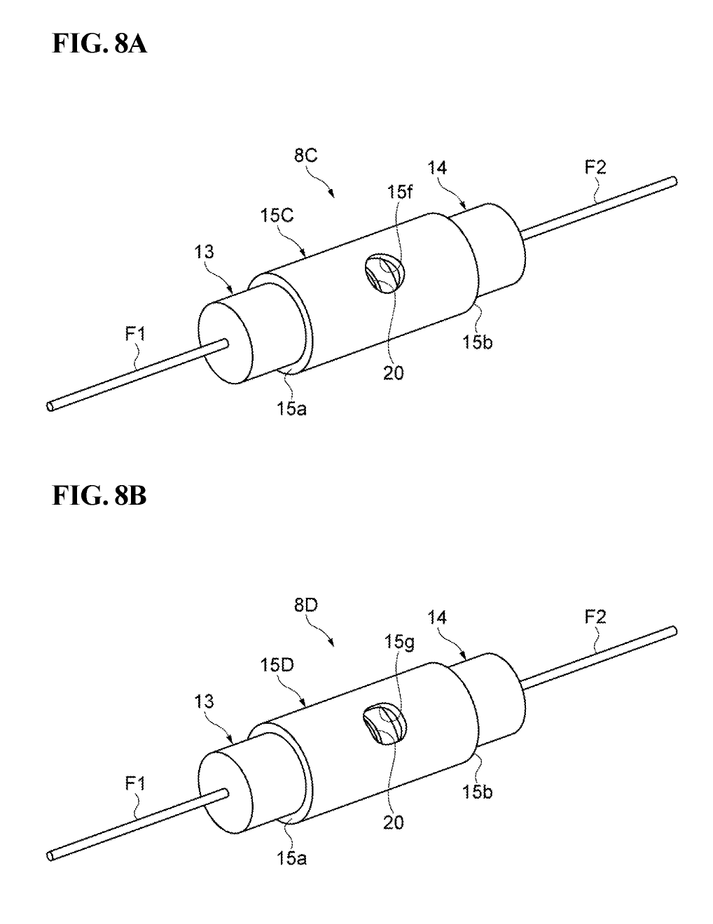

Other configurations in which the gap 20 is open to the outside is illustrated in FIGS. 8A and 8B. As illustrated in FIG. 8A, an optical fiber connector 8C includes a sleeve 15C having a circular slit 15f. As illustrated in FIG. 8B, an optical fiber connector 8D includes a sleeve 15D having a rectangular slit 15g. The s In each of such configurations, the feeding of the adhesive into the gap 20 between the leading end faces 13a and 14a and the discharge of the adhesive from the gap 20 can be performed while the strength of the sleeve 15C or 15D is maintained.

In addition, the optical fiber connector 8B may be assembled by applying uncured adhesive to the ferrule 13 and/or the ferrule 14 and then inserting the ferrules 13 and 14 having the uncured adhesive into the slit sleeve 15B, as in the assembling method according to the first embodiment.

### Second Modification

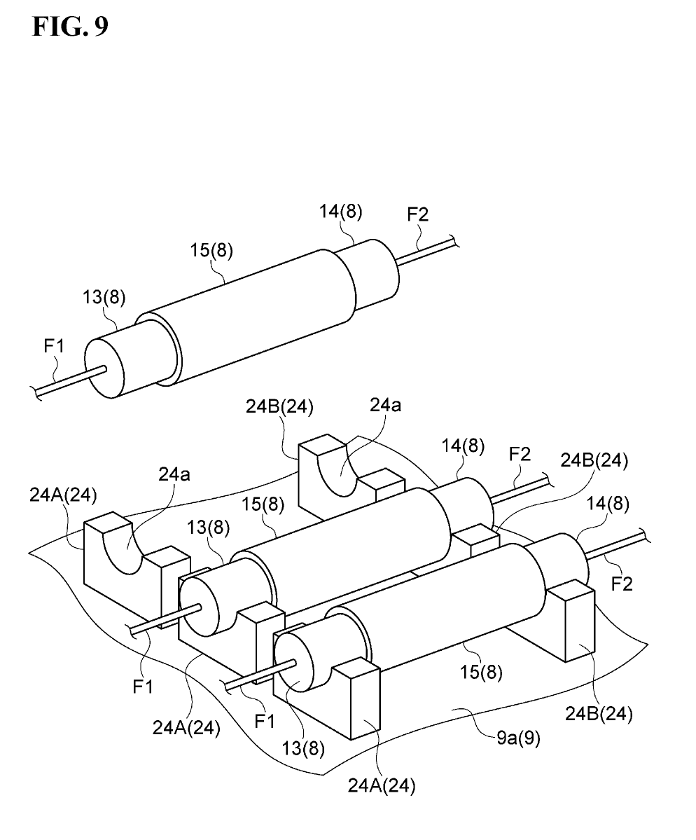

As illustrated in FIG. 9, holder portions 24 may be employed. The holder portions 24 each include a pair of projections 24A and 24B each having a U-shaped receiving portion 24a. The projections 24A and 24B may be provided on the bottom surface 9a or side surfaces of the case 9 forming the housing 2, or on the back surface 11a of the lid 11.

### Third Modification

While the first embodiment concerns the optical transceiver 1 as an exemplary apparatus including the optical fiber connector 8, the optical fiber connector 8 may be applied not only to an optical transceiver but also to an optical transmitter or an optical receiver. In that case, the packaging density of the optical transmitter or the optical receiver can be increased.

What is claimed is:

1. An optical fiber connector that optically couples a first optical fiber to a second optical fiber, the optical fiber connector comprising:
a first ferrule having a first peripheral surface, a first through hole, and a first end face, the first through hole receiving the first optical fiber;
a second ferrule having a second peripheral surface, a second through hole, and a second end face, the second through hole receiving the second optical fiber, the second end face being apart from the first end face with a gap;
a sleeve having a third peripheral surface and a third through hole, the third through hole receiving the the first ferrule and the second ferrule; and
an adhesive provided in the gap between the first and the second end faces,
wherein the first ferrule and the second ferrule are to be fixed to an inner peripheral surface of the sleeve with the adhesive.

2. The optical fiber connector according to claim 1, wherein the first and the second end faces are surrounded by a first and a second chamfers, respectively, and
wherein the first and the second chamfers are in contact with the adhesive.

3. The optical fiber connector according to claim 1, wherein the sleeve includes a slit hole connecting the third peripheral surface and the inner peripheral surface, and
the first and the second peripheral surfaces of the first and the second ferrules, and the adhesive are exposed from the slit hole.

4. The optical fiber connector according to claim 3, wherein the slit hole extends through the sleeve from an one end to an another end of the sleeve.

5. An optical apparatus comprising:
a first optical fiber;
a second optical fiber;
the optical fiber connector according to claim 1 that optically couples the first optical fiber to the second optical fiber; and
an optical sub-assembly connected to the first and second ferrules and including a light-emitting element.

6. An optical transceiver comprising:
a housing;
a first optical fiber;
a second optical fiber;
the optical fiber connector according to claim 1 that optically couples the first optical fiber to the second optical fiber; and
an optical sub-assembly that is optically coupled to the second optical fiber and that includes a light-emitting element and a light-receiving element,
wherein the housing includes a holder portion holding the optical fiber connector.

7. A method of manufacturing an optical fiber connector in which a first optical fiber is optically coupled to a second optical fiber, the method comprising:
a step of preparing
a first ferrule having a first peripheral surface, a first through hole and a first end face, the first through hole receiving the first optical fiber, and
a second ferrule having a second peripheral surface, a second through hole and a second end face, the second through hole receiving the second optical fiber;
a sleeve having a third peripheral surface and a third through hole;
a step of applying an adhesive to the first and/or the second end faces of the first and/or the second ferrules, the adhesive being uncured;
a step of inserting the first and the second ferrules into the third through hole of the sleeve, the second end face being apart from the first end face with a gap; and
a step of curing the adhesive so that the adhesive fixes the first and the second ferrules inside the third through hole of the sleeve.

8. The method of manufacturing an optical fiber connector according to claim 7,
wherein, after the step of inserting the first and the second ferrules into the third through hole, the adhesive is provided using a slit hole of the sleeve in the step of applying the adhesive to the first end face of the first ferrule.
